(19) United States
(12) Patent Application Publication
(10) Pub. No.: US 2007/0095802 A1
(43) Pub. Date: May 3, 2007

(54) LASER TREATMENT APPARATUS

(75) Inventor: Ga-Lane Chen, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,502

(22) Filed: Aug. 14, 2006

(30) Foreign Application Priority Data
Nov. 3, 2005 (CN) 200510100952.1

(51) Int. Cl. B23K 26/08; B23K 26/14; B23K 26/03

(52) U.S. Cl. 219/121.62; 219/121.82; 219/121.84; 219/121.83

(57) ABSTRACT

A laser treatment apparatus includes a laser generation unit for applying a laser beam to a workpiece; a control unit for regulating and controlling laser generation of the laser beam generated by the laser generation unit; a focusing unit for focusing the laser beam generated by said laser generation unit onto the workpiece; a table for supporting the workpiece; at least one thermal electric cooler positioned on the table for dissipating heat from a treatment position; and a feedback unit for receiving the laser beams reflected from the surface of the workpiece and generating and feeding a corresponding feedback signal according to the received laser beams back to the control unit.

### CROSS-REFERENCE TO RELATED APPLICATIONS

This application is related to commonly-assigned co-pending applications entitled, “LASER WELDING SYSTEM FOR WELDING WORKPIECE”, filed on Jun. 23, 2006 (U.S. application Ser. No. 11/473,965), “LASER SYSTEM AND METHOD FOR PATTERNING MOLD INSERTS”, filed on Jul. 28, 2006 (U.S. application Ser. No. 11/309,343), and “APPARATUS FOR PROCESSING WORK-PIECE”, filed on Jul. 31, 2006 (U.S. application Ser. No. 11/309,353). Disclosures of the above identified applications are incorporated herein by reference.

### TECHNICAL FIELD

The present invention relates to treatment apparatuses, and particularly to a laser treatment apparatus.

### DISCUSSION OF RELATED ART

Lasers have been used for surface treatments such as marking and machining of materials since shortly after their invention. Established techniques include laser cutting, laser drilling, and laser welding. These techniques have been applied to a wide range of materials including metals, ceramics, polymers, and natural products such as cotton and paper.

When using lasers to treat a workpiece, laser radiation is usually focused into a focal spot on the surface of a workpiece being treated and delivered in a sequence of pulses. Generally, laser treatment apparatuses make use of ablation and removal of unwanted materials of the workpiece as a result of melting and evaporation. Techniques involving laser treatment apparatuses have some advantages over other such techniques including higher efficiency and speed.

Several problems may be encountered in performing such laser treatment operations. For example, some molten materials maybe not evaporate in time during treatment, and the molten material that does not evaporate is deposited on the treatment region of the workpiece, causing heat to disperse non-uniformly. A number of recast layers and micro-cracks are formed on the treated surface of the workpiece thus reducing surface quality.

### SUMMARY

An exemplary embodiment of the present laser treatment apparatus is provided.

The laser treatment apparatus includes a laser generation unit for applying a laser beam to a workpiece; a control unit configured for regulating and controlling laser generation of the laser generation unit; a focusing unit configured for focusing the laser beam generated by the laser generation unit onto the workpiece; a table for supporting the workpiece; at least one thermal electric cooler configured on the table for dissipating heat from a treatment position; and a feedback unit for receiving the laser beams reflected from the surface of the workpiece and generating and feeding a corresponding feedback signal according to the received laser beams back to the control unit.

### BRIEF DESCRIPTION OF THE DRAWINGS

Many aspects of the present laser treatment apparatus can be better understood with reference to the following drawings. The components in the drawings are not necessarily drawn to scale, the emphasis instead being placed upon clearly illustrating the principles of the present laser treatment apparatus. Moreover, in the drawings, like reference numerals designate corresponding parts throughout the several views.

FIG. 1 is a schematic view of a laser treatment apparatus in accordance with a preferred embodiment; and

FIG. 2 is a schematic, enlarged view showing surface roughness of a product treated by the laser treatment apparatus of FIG. 1.

### DETAILED DESCRIPTION OF PREFERRED EMBODIMENTS

Reference will now be made to the drawings to describe in detail the preferred embodiments of the present laser treatment apparatus.

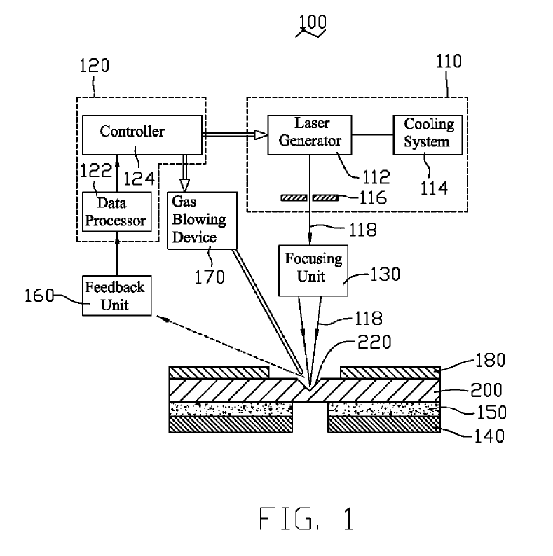

Referring to FIG. 1, a laser treatment apparatus 100 according to a preferred embodiment of the present invention is shown. The laser treatment apparatus 100 includes a laser generation unit 110, a control unit 120, a focusing unit 130, a table 140, at least one thermal electric cooler 150 arranged on the table 140, and a feedback unit 160.

The laser generation unit 110 includes a laser 112, a cooling system 114, and a blocking shutter 116. The laser 112 is adapted for generating a laser beam 118, and can be a high power solid-state laser, such as Nd: GdVO4 (neodymium doped gadolinium vanadate) laser with a wavelength of 1060-1340 nm, Nd:YAG (neodymium yttrium aluminium garnet) laser with a wavelength of 1064 nm, or Nd: YVO4 (neodymium doped yttrium orthovanadate) laser with a wavelength of 1064 nm. Preferably, the laser 112 is a laser diode pumped solid-state laser. The cooling system 114 is attached to the laser 112 for regulating a temperature of the laser 112. The blocking shutter 116 is configured for allowing the laser beam 118 to pass through itself and for regulating exposure of the workpiece to the laser beam 118 according to the control unit 120. For example, if the blocking shutter 116 is completely opened, the laser beam 118 completely passes through the blocking shutter 116. In this case, the exposure of the workpiece is maximum. If the blocking shutter 116 is completely closed, the laser beam 118 cannot pass through the blocking shutter 116. In this case, the exposure of the workpiece is minimum.

The control unit 120 includes a data processor 122 and a controller 124. The data processor 122 is adapted for processing the feedback signal from the feedback unit 160 and updating controlling parameters stored therein. The feedback signal can consist of information about a distance between the treatment position 220 of the workpiece 200 and the focusing unit 130. The controller 124 is adapted for regulating and controlling the laser generation unit 110 to generate the laser beam 118 according to the updated controlling parameters of the data processor 122. The updated controlling parameters of the data processor 122 include at least one of the following factors: laser pulse power, laser pulse energy, laser pulse duration, laser pulse repetition rate, and laser wavelength.

The focusing unit 130 includes a number of lenses configured for focusing the laser beam 118 onto the treatment position 220.

The table 140 can be structured and arranged to be movable vertically and horizontally so that different positions on the workpiece 200 can be treated by the laser.

The at least one thermal electric cooler 150 is attached on a surface of the table 140 for dissipating heat from the treatment position 220, and the at least one thermal electric cooler 150 can be disposed at any position of the surface of the table 140 according to need.

The feedback unit 160 includes a photoelectric detector. The feedback unit 160 is adapted for receiving the laser beams reflected from the surface of the workpiece 200 and generating and feeding the corresponding feedback signal according to the received laser beams back to the control unit 120.

The laser treatment apparatus 100 further include a clamp 180 for fixing the workpiece 200.

In addition, the laser treatment apparatus 100 may further include a gas blowing device 170. The gas blowing device 170 is configured for blowing gas onto the treatment position 220 of the workpiece 200 to accelerate the evaporation of a gaseous portion of the workpiece 200 melted by the laser beam 118. The gas blowing device 170 can be connected with the control unit 120 and be controlled by the control unit 120.

A process for treating a workpiece with above-described laser treatment apparatus 100 should include the steps of:

(1) setting controlling parameters in the data processor 122;

(2) controlling the laser 112 to generate the laser beam 118 according to the controlling parameters from the data processor 122;

(3) placing a workpiece 200 on the table 140 and fixing it in place with a clamp 180;

(4) opening the blocking shutter 116 and directing the laser beam 118 into the blocking shutter 116 and focusing it onto the treatment position 220 of the workpiece 200;

(5) receiving the laser beams reflected from the surface of the workpiece 200 and generating and feeding a corresponding feedback signal of the position of the surface being treated on the workpiece 200 according to the received laser beams back to the control unit 120;

(6) processing the feedback signals by the data processor 122 to obtain updated controlling parameters and transmitting the updated controlling parameters to the controller 124;

(7) regulating the laser generation of the laser 112 according to the updated controlling parameters received by the controller 124;

(8) repeating the steps (2) to (7) until the workpiece 200 is processed and treated into a satisfactory product.

The workpiece can be made of steel, aluminum alloy, manganese alloy, titanium alloy, nickel alloy, tin alloy, copper alloy, lead alloy, and all kinds of low carbon steels.

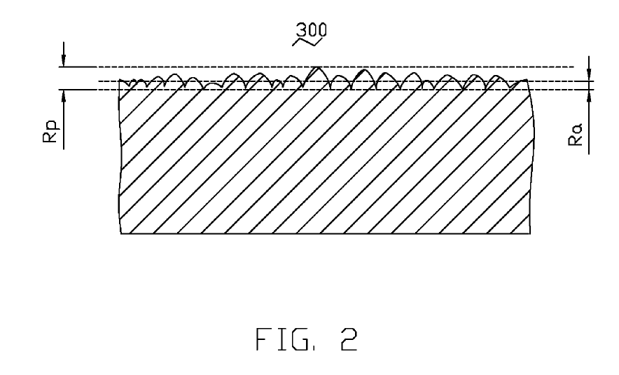

Referring to FIG. 2, a schematic view showing a surface roughness of a product 300 treated by the laser treatment apparatus 100 is shown. The arithmetical mean deviation of the surface profile of the product 300 is labeled with a character Ra and the maximum peak height of the surface profile of the product 300 is labeled with a character Rp. Ra of the product 300 treated by the laser treatment apparatus is in the range from about 0.5 nm to 2 nm and Rp is in the range from about 1.5 nm to 6 nm. Therefore, the treated surface of the product 300 can be considered to be smooth.

An advantage of the laser treatment apparatus 100 is that the laser 112 can be adjusted during treatment, and the thermal electric cooler 150 can remove the superfluous heat formed by the molten material without evaporation in time to avoid recast layers and micro-cracks being formed on the treated surface of the product 300.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Furthermore, this application is intended to cover such departures from the present disclosure as come within known or customary practice in the art to which the invention pertains and which fall within the limits of the appended claims or equivalents thereof.

What is claimed is:

1. A laser treatment apparatus comprising:
a laser generation unit configured for applying a laser beam to a workpiece;
a control unit configured for regulating and controlling the laser generation of the laser beam by the laser generation unit;
a focusing unit configured for focusing the laser beam generated by the laser generation unit onto the workpiece;
a table configured for supporting the workpiece;
at least one thermal electric cooler arranged on the table, the at least one thermal electric cooler being configured for dissipating heat from a treatment position; and
a feedback unit configured for receiving the laser beams reflected from the surface of the workpiece and generating and feeding a corresponding feedback signal back to the control unit.

2. The apparatus as claimed in claim 1, wherein the laser generation unit comprises a laser for generating the laser beam, a cooling system attached to the laser for regulating a temperature of the laser, and a blocking shutter configured for regulating exposure of the workpiece to the laser beam.

3. The apparatus as described in claim 2, wherein the laser is a laser diode pumped solid-state laser.

4. The apparatus as described in claim 1, wherein the control unit comprises a data processor configured for processing the feedback signal from the feedback unit and updating controlling parameters stored therein, and a controller configured for controlling the laser generation unit to generate the laser beam according to the updated controlling parameters of the data processor.

5. The apparatus as described in claim 4, wherein the controlling parameters include at least one of following parameters: laser pulse power, laser pulse energy, laser pulse duration, and laser pulse repetition rate.

6. The apparatus as described in claim 1, wherein the focusing unit comprises a plurality of lenses.

7. The apparatus as described in claim 1, wherein the feedback unit includes a photoelectric detector.

8. The apparatus as described in claim 1, further comprising a gas blowing device configured for blowing gas to a treatment region of the workpiece.
